(19) United States
(12) Patent Application Publication
(10) Pub. No.: US 2005/0214519 A1
(43) Pub. Date: Sep. 29, 2005

(54) Sugar as a binder for muffler preforms

(76) Inventor: Christopher J. Clements, White Lake, MI (US)

Correspondence Address: OWENS CORNING, 2790 COLUMBUS ROAD, GRANVILLE, OH, 43023, US

(21) Appl. No.: 10/811,249

(22) Filed: Mar. 26, 2004

(51) Int. Cl. B32B 3/00; B32B 17/00; B32B 27/12; D04H 3/00; D04H 13/00; D02G 3/00; D04H 1/00; D04H 5/00; B32B 3/26; B29C 43/10; B32B 18/00; B32B 17/12; B29C 49/00

(52) U.S. Cl. 428/299.4; 428/364; 428/294.1; 428/426; 428/300.1; 428/312.6; 428/205; 428/210

(57) ABSTRACT

A process for forming muffler preforms using sugar as a binder is provided. Continuous glass strands and sugar are added to a preform mold which has the general shape and approximate volume of the internal cavity of the muffler in which the muffler preform is to be inserted. The sugar may be a sugar that has a melting point of 130° F. or greater. The continuous glass strands may be fed into the preform mold by a feeder that separates the strands and entangles the individual fibers. The preform mold is heated to a temperature sufficient to melt or at least partially caramelize the sugar. Once melted, the sugar adheres to the individual glass fibers, causing the individual glass fibers to stick together. The preform mold may be cooled to bind the sugar-coated glass fibers and form a muffler preform formed of continuous glass fibers bound together by sugar.

### TECHNICAL FIELD AND INDUSTRIAL APPLICABILITY OF THE INVENTION

The present invention relates generally to a binder for glass fibers, and more particularly, to the use of sugar as a binder for continuous glass fibers in muffler preforms.

### BACKGROUND OF THE INVENTION

Acoustical sound insulators are used in a variety of settings where it is desired to reduce noise emissions by dissipating or absorbing sound. For example, it is known in the art to use a sound absorbing material in exhaust mufflers for internal combustion engines to dampen or attenuate sound made by the engine exhaust gases as they pass from the engine through the exhaust system and into the atmosphere. Typically, continuous glass fiber strands are positioned internally in a muffler as the sound absorbing material. Continuous glass fibers are preferred over other fibers, such as chopped glass fibers, because the length of the continuous fibers decreases the possibility that free fibers may dislodge from the muffler and exit into the atmosphere.

Continuous glass fiber strands may be positioned in a muffler by a variety of methods known in the art. For example, continuous glass fiber strands may be inserted directly into a muffler shell, such as is disclosed in U.S. Pat. No. 4,569,471 to Ingemansson et al. In particular, Ingemansson et al. disclose a process and apparatus for filling muffler shells by feeding continuous multifilament glass fiber strands through a nozzle and into a muffler outer shell. Compressed air is used expand the fiber strands into a wool-like material inside the shell.

U.S. Pat. No. 6,446,750 to Lewin discloses another method for filling a muffler shell with continuous glass fiber strands. In this method, a muffler shell including first and second muffler shell outer parts and an internal structure defining a channel in communication with the internal cavity of the muffler shell is first provided. Next, a form is placed over the internal structure and the first muffler shell outer part. A partial vacuum is drawn through a first end of the channel as a fibrous material (e.g., continuous glass fiber strands) is fed into the form. The form is then removed and the second muffler shell part is positioned over the internal structure and the first muffler shell part.

U.S. Pat. No. 6,607,052 to Brandt et al. discloses a process for filling a muffler shell with continuous glass fiber strands in which a bag is filled with continuous glass fibers and inserted into a muffler cavity. The bag has a first side with one or more first perforations defining a first side total open area and a second side with either no perforations or one or more second perforations defining a second side total open area. The first side total open area is greater than the second side total open area. The bag is filled with a fibrous material (e.g., continuous glass fiber strands) and positioned adjacent to an internal structure located within a first muffler shell part. A partial vacuum is applied to draw the filled bag towards the internal structure. A second muffler shell part is then placed adjacent to the first muffler shell part such that the first and second muffler shell parts define an internal cavity containing the internal structure and the fibrous material-filled bag.

U.S. Pat. No. 6,412,596 to Brandt et al. describes a process for filling a muffler shell with a fibrous material (e.g., continuous strand glass). First, a muffler having an outer shell, an inner cavity, and at least one perforated pipe is provided. The muffler shell may contain any number of partitions (e.g., zero or more) within the inner cavity. A fibrous material is fed into the inner cavity via a pressurized air flow through the perforated pipe. The pressurized air separates and entangles the filaments of the strand material such that the strand material emerges from the pipe as a continuous length of “fluffed up” fibrous material.

U.S. Pat. No. 6,581,723 to Brandt et al. describes a process for filling a muffler shell with fibrous material that includes placing a sheet having a first side and a second side adjacent to a perforated tool and applying a vacuum to draw the sheet against the tool. An internal structure having one or more perforated elements is then placed on the sheet. Next, a first muffler shell outer part is placed adjacent to the tool such that a temporary inner cavity is defined by the tool and the first muffler shell outer part. Fibrous material is fed into the temporary inner cavity. A partial vacuum is then applied, which causes the fibrous material and the sheet to be drawn towards the internal structure. The first outer part, the internal structure, the fibrous material, and the sheet are then removed from the tool. A second muffler shell outer part is affixed to the first muffler shell outer part to form a muffler.

In addition to filling a muffler shell with continuous glass fiber strands, it is also known in the art to form preforms of continuous glass fiber strands which are adapted to be inserted into a muffler shell. U.S. Pat. No. 5,766,541 to Knutsson et al. discloses a preform of continuous glass fiber strands made by feeding continuous glass fiber strands into a perforated mold to form a continuous wool product in the mold, feeding a binder into the mold, compressing the mold to compact the wool product to a desired density, heating the mold to cure the binder, and removing the preform from the mold. The preform may then be inserted into a muffler cavity.

In U.S. Patent Publication No. 2001/0011780 A1 to Knutsson, continuous glass fiber strands and a powder binder are blown into a cavity formed of a perforated screen having the shape of the muffler to be filled. Hot air is then passed through the perforated screen to melt the binder and bond the fibers together. Next, cool air is circulated through the screen to cool the preform so that it can be removed from the screen and inserted into a muffler.

The binder used in forming muffler preforms is typically a thermoset phenolic resin that is distributed in powder form along with the continuous glass fiber strands. The binder is used to hold or retain the glass fibers in the preform shape until preform is installed into the muffler. However, once the preform is installed in the muffler, the binder is no longer needed, and is typically burned off by running the vehicle for a period of time sufficient to remove at least a substantial portion of the binder from the preform.

Phenolic binders such as are used in continuous glass fiber strand preforms for mufflers have many undesirable characteristics. For example, because the binder is distributed in powder form throughout the glass fibers, a large amount of binder is needed to bind the glass fibers and achieve the desired level of integrity within the preform. In addition, the large amount of binder distributed throughout the preform requires a long cure time to fully cure the binder because the entire preform must be heated to the appropriate binder cure temperature and must be held at that temperature for the entire cure time. This extended cure time results in increased production cycle time and increased cost. Further, the decomposition of the binder during bum-off releases noxious gases and odors that are undesirable.

Thus, there exists a need in the art for an alternative binder composition that is environmentally friendly and which effectively reduces the costs associated with phenolic powder binders currently used in muffler preforms.

### SUMMARY OF THE INVENTION

It is an object of the present invention to provide a method for forming a muffler preform that uses sugar as a binder. To form a muffler preform having a sugar binder, continuous glass strands are fed into a preform mold having the general shape and approximate volume of the internal cavity of the muffler in which it is to be inserted. The preform mold may be formed of a first half and a second half. Continuous glass strands may be blown by air into the preform mold through an opening or orifice. The expansion of the air flow into the preform mold separates the glass strands and entangles the individual fibers to give the fibers a wool-like appearance. Sugar may be dispensed into the preform mold along with the continuous glass strands to act as a binder and hold the glass fibers together. Preferably, the sugar is a sugar that has a melting point of 130° F. or higher. Heat may be applied to raise the temperature of the sugar equal to or above its melting point for a period of time sufficient melt the sugar or at least partially caramelize the sugar. As the sugar melts, it forms a sticky, viscous, molten sugar product which adheres to the individual glass fibers throughout the preform mold. The heated preform mold may then be cooled to bind the sugar-coated glass fibers together and set the muffler preform into its desired shape. Once the preform has been cooled, it may be removed from the preform mold and inserted directly into a muffler or stored for later use.

It is another object of the present invention to provide a method of forming a muffler preform that has an encapsulating shell of bound glass fibers surrounding internal, unbound glass fibers within the preform. To form such a muffler preform, a sugar may be placed on internal walls of a preform mold. Preferably, the sugar is a sugar that has a melting point of 130° F. or higher. In at least one embodiment of the invention, the sugar is a molten or dissolved sugar. Once the sugar has been placed onto the internal walls, continuous glass fibers may then be fed into the preform mold via a pressurized air flow. The air flow may separate the glass strands and entangle the individual glass fibers to give the fibers a wool-like appearance. The preform mold may then be heated to a temperature sufficient to melt or at least partially caramelize the sugar. Next, the preform mold may be cooled to bind the sugar-coated glass fibers together and form a muffler preform. Because the binder is applied directly to the internal walls of the preform mold, glass fibers located adjacent to the preform walls are bound together by the sugar upon heating. However, glass fibers not located adjacent to the walls of the preform mold remain in an unbound, fibrous form. The result is an integral, substantially contiguous surface that encapsulates the unbound glass fibers contained within the preform mold.

It is a further object of the present invention to provide a preform that is formed of continuous glass strands formed into a predetermined shape (e.g., a muffler preform) bound together by a sugar that has been melted and cooled to form a binder. The sugar is preferably a sugar that has a melting point of 130° F. or higher, such as sucrose.

The foregoing and other objects, features, and advantages of the invention will appear more fully hereinafter from a consideration of the detailed description that follows.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

The present invention relates to the use of sugar as a binder for glass fibers in muffler preforms. The sugar may be added in either a powdered form or in a liquid form. In addition, the sugar may be added to a preform mold along with the continuous glass fibers or the sugar may be applied to the inside surface of a preform mold prior to filling the preform mold with continuous glass fibers as described in detail below.

To form a muffler preform having a sugar binder, continuous glass strands are fed into a preform mold having a first half and a second half, such that when the first half and the second half are assembled, the preform mold has the general shape and approximate volume of the internal cavity of the muffler in which muffler preform is to be inserted. In addition, the preform mold includes an opening or orifice through which the continuous fibers are fed. The opening may be of any shape or length. Preferably, the preform mold is perforated with a plurality of holes so that air, but not the continuous glass fibers, can pass through the mold. The preform mold may be formed of any suitable material such as a screen, mesh, or perforated metal. In preferred embodiments, the preform mold has a non-stick surface, such as Teflon.

Continuous glass fibers may be formed by any conventional method, such as by drawing or attenuating molten glass from a bushing or orifice. The continuous glass fibers may then be collected into a continuous glass strand and wound into a roving. Examples of glass fibers suitable for use in a muffler preform include E-type glass fibers, S-type glass fibers, and Advantex® glass fibers. Other heat resistant fibers, such as continuous basalt fibers (e.g., rock wool), may alternatively be used to form the muffler preform. Glass fibers are preferred for use in mufflers because of their sound attenuation capability and resistance to the extreme heat conditions produced within the muffler.

The continuous glass strands may be blown by air into the preform mold through the opening in the preform mold. Preferably, the air is pressurized by a conventional compressor and supplied by a hollow conduit in direct communication with the opening in the preform mold. As the continuous glass strands are fed into the preform mold, the expansion of the air flow into the preform mold separates the glass strands and entangles the individual fibers to give the fibers a “fluffed-up” or wool-like appearance. A vacuum may be applied to the exterior of the preform mold to evenly distribute the continuous glass fibers within the preform mold. The continuous glass strands are fed into the preform mold until the mold has been filled with a desired quantity of glass fibers. A counter may be used to measure the amount of glass strands being fed into the preform mold.

In at least one exemplary embodiment, the continuous glass strands are fed into the preform mold by a strand feeder. The strand feeder may include one or more strand feeding mechanisms that feed one or more continuous strands of glass fibers into the preform mold. In addition, the strand feeder may optionally texturize one or more of the continuous glass strands by separating the strand into individual glass fibers prior to feeding the glass fibers into the preform mold. Examples of suitable strand feeders include the feeding mechanism shown and described in U.S. Pat. No. 4,569,471 to Ingemansson et al. and the commercially available Silentex™ machine available from Owens Corning.

Sugar may be dispensed into the preform mold along with the continuous glass strands to act as a binder and hold the glass fibers together. Alternatively, the sugar may be added prior to the addition of the glass fibers. Preferably, the sugar is dispensed in a powdered or granular form. Sugar may be advantageously employed as a binder for the continuous glass fibers in the preform in part due to its low cost. In addition, because sugars are non-hazardous substances, no special precautions need to be taken when handling or applying the sugar, unlike conventional phenolic binders.

The term “sugar” as it is used herein is a generic term meant to indicate sugars which are useful as binders in the instant invention, such as, but not limited to, monosaccharides, disaccharides, polysaccharides, and their degradation products. Preferably, the sugar has a melting point of 130° F. or higher. Suitable examples of sugars include, but are not limited to, glucose, sucrose, lactose, and galactose. A number of sugar syrups such as corn syrup, high fructose corn syrup, and molasses may also be used. The sugars used in the instant invention may be sugars having a commercial grade and do not necessarily need to be food grade quality.

When the sugar is added to the preform mold together with the continuous glass strands, the sugar is distributed substantially evenly throughout the glass fibers. The sugar may be added to the preform mold in either a liquid or a powder form using metering equipment and feeding apparatuses currently used for conventional binders. Therefore, no extra expenses are incurred by using a sugar as a binder. The sugar may be added in an amount of approximately 2-10% by weight of the final preform.

After the sugar and the continuous glass strands have been fed into the preform mold, heat may be applied to form a muffler preform. It is to be noted that although muffler preforms are discussed herein as a preferred embodiment, sugar may be used as a binder in applications in which the binder is temporarily needed or subsequently removed, such as by heat. Heat may be applied to the preform mold in any manner sufficient to raise the temperature of the sugar equal to or above its melting point. For example, the sugar may be heated by blowing hot air through the preform mold or by placing the preform mold into an oven. Preferably, heat is applied for a period of time sufficient to melt or at least partially caramelize the sugar. The caramelized sugar creates a stronger bond between the glass fibers than a bond formed by the re-crystallization of melted sugar. As the sugar melts, it forms a sticky, viscous, molten sugar product which adheres to the individual glass fibers throughout the preform mold.

The heated preform mold may then be cooled, such as by circulating cool air through the preform mold, to bind the sugar-coated glass fibers together and set the muffler preform into its desired shape. Once the bound glass fibers are cooled, the muffler preform is removed from the preform mold. The muffler preform may then be inserted directly into a muffler, such as in an in-line process, or it may be stored for insertion into a muffler at a later time. Preferably, if the muffler is stored for later use, it is stored in a sealed container.

In an alternative embodiment, sugar is applied directly to the internal walls of the preform mold prior to the addition of the continuous glass strands. Preferably the sugar is applied in a liquid form, such as, for example, a molten or dissolved sugar. By applying the sugar directly to the internal walls of the preform mold, glass fibers located adjacent to the walls are bound together by the sugar upon heating. However, glass fibers positioned internally (e.g., glass fibers which are not located adjacent to the walls of the preform mold) remain in an unbound, fibrous form. The result is an integral, substantially contiguous surface that encapsulates the unbound glass fibers contained within the preform mold. In addition, because the sugar binder is located adjacent to the internal walls and not throughout the preform mold, less costly methods of heating, such as infra-red heating, induction heating, or a low velocity convection oven may be utilized to heat the preform mold. It is to be noted that although this alternative embodiment is described herein with respect to using sugar as a binder to hold the glass fibers together, conventional binders could be used to coat the internal walls of the preform mold and form an encapsulating shell of bound glass fibers.

In a further alternative embodiment, the preform mold is heated to a temperature above the melting point of the sugar prior to the application of the sugar to the internal walls. If the sugar is applied in a molten state, the sugar remains in a molten state on the heated wall and adheres to the continuous glass fibers as they are fed into the preform mold. The preform mold may then be cooled to bind the glass fibers located adjacent to the walls forming an encapsulating, integral surface (e.g., shell) surrounding the unbound glass fibers.

On the other hand, if the sugar is a dissolved sugar (e.g., a sugar in solution), the heat of the preform mold causes the water in the dissolved sugar solution to be partially or completely evaporated, leaving the sugar adhered to the internal walls. After the continuous glass fibers are added to the preform mold, the preform mold is re-heated to melt the sugar and adhere the individual fibers located adjacent to the walls together. The preform may then be cooled to bind the glass fibers together and form an encapsulating surface (e.g., shell) of bound glass fibers.

With the sugar binder located at the surface of the muffler preform, less overall binder is needed to form a muffler preform with sufficient integrity to be placed in a muffler, thereby resulting in a reduction in cost associated with the binder. In addition, less costly methods of heating the muffler preform may be used to melt/cure the binder since the binder is positioned substantially only at the surface of the muffler preform, and not throughout the bulk of the preform. The cycle time to melt and/or cure the binder is also reduced. Another advantage of using sugar as a binder is that sugars have a faster decomposition rate than phenolic binders. Thus, the sugar binder can be burned off in a shorter period of time. The reduced quantity of sugar binder utilized within the preform corresponds to a reduced time required to effect a burn-off of the sugar binder and a reduced emission of noxious odors.

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A method of forming a preform having a predetermined shape comprising the steps of:
feeding sugar and glass fibers into a preform mold;
heating said preform mold to a temperature sufficient to melt said sugar, said melted sugar adhering to said glass fibers to form sugar-coated glass fibers; and
cooling said preform mold to bind said sugar-coated glass fibers together and form said preform.

2. The method of claim 1, wherein said glass fibers are continuous glass strands.

3. The method of claim 2, further comprising the step of:
texturizing said continuous glass strands by separating said continuous glass strands into individual glass fibers prior to feeding said continuous glass strands into said preform mold.

4. The method of claim 2, wherein said continuous glass strands and said sugar are simultaneously fed into said preform mold.

5. The method of claim 1, wherein said predetermined shape of said preform has a shape corresponding to a shape of an automobile muffler.

6. The method of claim 1, further comprising the step of:
removing said preform from said preform mold.

7. The method of claim 1, wherein said sugar is a sugar having a melting point of 130° F. or greater.

8. The method of claim 1, wherein said preform mold is perforated.

9. The method of claim 8, wherein said heating step comprises passing heated air through said preform mold for a period of time sufficient to at least partially caramelize said sugar.

10. The method of claim 8, wherein said cooling step comprises passing cool air through said preform mold.

11. A method of forming a preform comprising the steps of:
placing a binder on internal walls of a preform mold;
adding continuous glass strands to said preform mold; and
curing said binder to bond glass fibers positioned adjacent to said internal walls together and form said preform, said bonded glass fibers forming an encapsulating shell of bound glass fibers surrounding unbound glass fibers within said preform.

12. The method of claim 11, wherein said binder is a sugar having a melting point of 130° F. or greater.

13. The method of claim 12, wherein said curing step comprises the steps of:
heating said preform mold to a temperature sufficient to at least partially melt said sugar, said melted sugar adhering to said glass fibers to form sugar-coated glass fibers; and
cooling said preform mold to bind said sugar-coated glass fibers together and form said preform.

14. The method of claim 13, further comprising the step of:
heating said preform mold prior to placing said sugar on said internal walls.

15. The method of claim 11, further comprising the step of:
texturizing said continuous glass strands by separating said continuous glass strands into individual glass fibers prior to feeding said continuous glass strands into said preform mold.

16. The method of claim 11, further comprising the step of:
removing said preform from said preform mold.

17. A preform comprising continuous glass strands formed into a predetermined shape, said continuous glass strands being bound together by a sugar that has been melted and cooled to form a binder.

18. The preform of claim 17, wherein said sugar has a melting point of 130° F. or greater.

19. The preform of claim 18, wherein said sugar is selected from the group consisting of glucose, sucrose, lactose and galactose.

20. The preform of claim 19, wherein said predetermined shape of said preform corresponds to a shape of an automobile muffler.
